(19) United States
(12) Patent Application Publication
(10) Pub. No.: US 2013/0179414 A1
(43) Pub. Date: Jul. 11, 2013

(54) MECHANISMS FOR CONNECTING FILES BETWEEN APPLICATIONS

(71) Applicants: Scott David Hoogerwerf, Seattle, WA (US); David Charles Fields, Kirkland, WA (US); Michael John Novak, Redmond, WA (US); Richard Jacob White, Bellevue, WA (US); Dennis Lawrence Davis, Bothell, WA (US); Gabriel Shawn DeBacker, Carnation, WA (US); Jeffrey Jay Johnson, Bellevue, WA (US); Manav Mishra, Kirkland, WA (US); Steven James Ball, Redmond, WA (US)

(72) Inventors: Scott David Hoogerwerf, Seattle, WA (US); David Charles Fields, Kirkland, WA (US); Michael John Novak, Redmond, WA (US); Richard Jacob White, Bellevue, WA (US); Dennis Lawrence Davis, Bothell, WA (US); Gabriel Shawn DeBacker, Carnation, WA (US); Jeffrey Jay Johnson, Bellevue, WA (US); Manav Mishra, Kirkland, WA (US); Steven James Ball, Redmond, WA (US)

(73) Assignee: Microsoft Corporation, Redmond, WA (US)

(21) Appl. No.: 13/345,612

(22) Filed: Jan. 6, 2012

(51) Int. Cl. G06F 7/00

(52) U.S. Cl. 707/694; 707/E17.01; 707/E17.005

(57) ABSTRACT

The claimed subject matter provides for systems and/or methods for accessing and/or updating files by a first application in which the first application does not have direct accessibility to said file. In some embodiments, file host applications that are not directly accessible to said first application may be connected to through a file picker extensibility point that enable the first application to acquire files through an operating system user experience. In these various embodiments, the system may provide for one or more of the following functionalities: (1) refreshing content that is controlled by a file host application; (2) updating content that is controlled by a file host application; (3) exporting files from an application to a file host application; (4) a user interface for export operations and file host application intervention and (5) a file host extensibility point provided by the operating system.

### BACKGROUND

Within a traditional computer system environment, users work with files and documents via user applications that are available to the computer system. The saving of these user files and documents is typically accomplished by a command available to the user within the application itself.

In addition, such files are typically saved on computer storage media (e.g., hard disks, drives and the like) that are either directly or indirectly connected to the computer system (e.g. physically resident upon the computer system or connected in a wired or wireless fashion).

In situations where a user or users are working with a file within two or more applications, a copy of the data may be imported/exported from one application to the other. As such, it may be the case that a given user may not be working with the latest version of thee file in question.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Some embodiments of the present application provide for systems and/or methods for accessing and/or updating files by a first application in which the first application does not have direct accessibility to said file.

In some embodiments, file host applications that are not directly accessible to said first application may be connected to through a file picker extensibility point that enable the first application to acquire files through an operating system user experience.

In these various embodiments, the system may provide for the one or more of the following functionalities: (1) refreshing content that is controlled by a file host application; (2) saving content that is controlled by a file host application; (3) exporting files from an application to a file host application; (4) a user interface for export operations and file host application intervention and (5) a file host extensibility point provided by the operating system.

In other embodiments, first applications may make requests to save files to a different file host via such operating system user experience.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 illustrates an example system 100 implementing the file access with different file hosts techniques discussed herein in accordance with one or more embodiments.

FIG. 2A is an illustration of a system in an example implementation configured to perform file management.

FIG. 2B illustrates another example system implementing the file access with different file hosts techniques discussed herein in accordance with one or more embodiments.

FIG. 3 depicts a flow diagram in one embodiment of a present system of updating/accessing a file from a different file host

FIG. 4 depicts a flow diagram in one embodiment of a present system of saving a file to a different file host.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Introduction

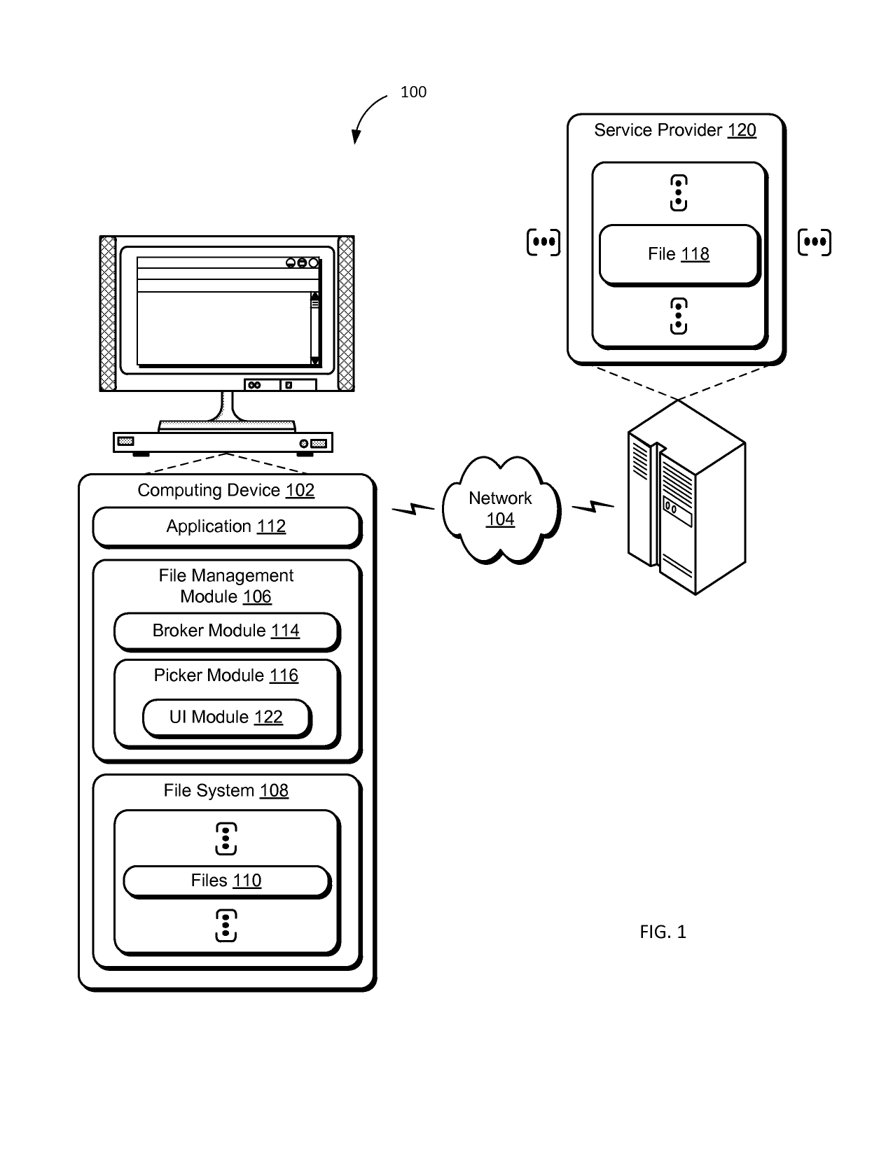

FIG. 1 illustrates an example system 100 implementing the file access with different file hosts techniques discussed herein in accordance with one or more embodiments. The illustrated system 100 includes a computing device 102, which may be configured in a variety of ways. For example, computing device 102 can be configured as a computer that is capable of communicating over a network 104, such as a desktop computer, a tablet or notepad computer, a mobile station, an entertainment appliance, a set-top box communicatively coupled to a display device, a television or other display device, a cellular or other wireless phone, a game console, and so forth.

Computing device 102 may range from a full resource device with substantial memory and processor resources (e.g., personal computers, game consoles) to a low-resource device with limited memory and/or processing resources (e.g., traditional set-top boxes, hand-held game consoles).

Additionally, although a single computing device 102 is shown, computing device 102 may be representative of multiple different devices, such as multiple servers utilized by a business to perform operations, a remote control and set-top box combination, an image capture device (e.g., camera) and a game console configured to capture gestures, and so on.

Computing device 102 can also include an entity (e.g., software) that causes hardware of the computing device 102 to perform operations, e.g., configures processors, functional blocks, and so on. For example, computing device 102 may include a computer-readable medium that may be configured to maintain instructions that cause the computing device, and more particularly hardware of computing device 102 to perform operations. Thus, the instructions function to configure the hardware to perform the operations and in this way result in transformation of the hardware to perform the operations. The instructions may be provided by the computer-readable medium to computing device 102 through a variety of different configurations.

One such configuration of a computer-readable medium is signal bearing medium and thus is configured to transmit the instructions (e.g., as a carrier wave) to the hardware of the computing device, such as via network 104. The computer-readable medium may also be configured as a computer-readable storage medium and thus is not a signal bearing medium. Examples of a computer-readable storage medium include a random-access memory (RAM), read-only memory (ROM), optical discs (e.g., DVD or CD), flash memory, hard disk memory, and other memory devices that may use magnetic, optical, and other techniques to store instructions and other data.

Network 104 can assume a variety of different configurations. For example, network 104 can include the Internet, a wide area network (WAN), a local area network (LAN), a personal area network (PAN), a wireless network, a public telephone network, an intranet, combinations thereof, and so on. Further, although a single network 104 is shown, network 104 may be configured to include multiple networks.

Computing device 102 is illustrated as including a file management module 106. File management module 106 is representative of functionality to manage access to one or more files, including files in a file system 108. File management module 106 can be implemented in a variety of ways, such as a stand-alone application, as part of an operating system of computing device 102, as an application that executes in conjunction with the operating system, and so on.

File system 108 employs techniques to organize and store files 110 by computing device 102. File system 108, for instance, can employ a hierarchy of folders to manage files 110 (e.g., executable and/or library files) in storage. A variety of other file management techniques that may be employed by file management module 106 and file system 108 are contemplated. Additionally, a variety of different types of files 110 can be managed using file management module 106. For example, files 110 can be text (document) files, image files, video files, audio files, combinations thereof, and so forth.

An application 112 is one or more programs, scripts, or other collections of instructions that run on computing device 102. Application 112 can assume a variety of different configurations, such as an entertainment application (e.g., a game or audio/video player), a utility application (e.g., a word processor or Web browser), a reference application (e.g., a dictionary or encyclopedia), and so forth. Application 112 can be one or more programs, scripts, or other collections of instructions that run on computing device 102 and can be stored as files 110. Alternatively, application 112 can be one or more programs, scripts, or other collections of instructions that are downloaded from a remote service (e.g., via network 104) and run on computing device 102 without being stored as files 110. Or, application 112 can be one or more programs, scripts, or other collections of instructions that are run on a remote service, with a user interface generated by the remote service and provided (e.g., via network 104) to computing device 102 for display, and inputs received at computing device 102 being returned (e.g., via network 104) to the remote service for processing.

In one or more embodiments, application 112 is an isolated application, being run in a manner in which the ability of application 112 to access resources (e.g., networked computers, the Internet, modules, devices, memory, other applications) of computing device 102 is restricted. The operating system (and/or other software, firmware, and/or hardware) of computing device 102 allows an isolated application to access memory and other resources of computing device 102 that have been allocated or otherwise made available to the isolated application, but prevents the isolated application from accessing other memory of, resources of, and/or applications running on computing device 102. This protects other applications running on computing device 102 from being interfered with by the isolated application, as well as protects the isolated application from being interfered with by other applications running on computing device 102, thus isolating the application from other applications on computing device 102.

In one or more embodiments, application 112 is run in a restricted manner by being run in a sandbox. Although a single application 112 is illustrated in computing device 102, it should be noted that multiple applications can be running in computing device 102 concurrently (each application being executed in its own sandbox).

File management module 106 is further illustrated as including a broker module 114 and a picker module 116. Broker module 114 is representative of functionality of file management module 106 to manage access of application 112 to various file hosts, such as file system 108, other applications, service providers, and so forth. Broker module 114, for instance, may act as an intermediary to locate files requested by application 112 and provide those files back to application 112. Further, such files may be provided to application 112 and application 112 need not be aware of where the files were obtained (e.g., the namespace used by file system 108, the host, and so forth). For example, broker module 114 can operate as an abstraction layer that isolates application 112 from specific details regarding various file hosts and the manner in which those file hosts store files.

Additionally, broker module 114 may employ picker module 116 to configure a user interface such that a user may select files from various file hosts. Picker module 116 includes a UI module 122 managing communication with file hosts as appropriate, including managing remote access (e.g., with service provider 120 over network 104). UI module 122 also manages at least a portion of a user interface based on communications with other file hosts. For example, UI module 122 can configure a portion of a user interface such that a user can select remote files that are accessible via a service provider 120 (e.g., implemented using one or more computing devices) over network 104, select remote files that are managed by an application of service provider 120, select files that are managed by other applications on computing device 102, and so forth.

Various modules and applications of computing device 102, such as application 112 and picker module 116, can receive user inputs from a user of computing device 102. These user inputs can provide data, user selections, and so forth. User inputs can be provided in a variety of different manners, such as by pressing one or more keys of a keypad or keyboard of device 102, pressing one or more keys of a controller (e.g., remote control device, mouse, trackpad, etc.) of device 102, pressing a particular portion of a touchpad or touchscreen of device 102, making a particular gesture on a touchpad or touchscreen of device 102, and/or making a particular gesture on a controller (e.g., remote control device, mouse, trackpad, etc.) of device 102. User inputs can also be provided via other physical feedback input to device 102, such as tapping any portion of device 102, an action that can be recognized by a motion detection component of device 102 (such as shaking device 102, rotating device 102, etc.), and so forth. User inputs can also be provided in other manners, such as via audible inputs to a microphone, via motions of hands or other body parts observed by an image capture device, and so forth.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

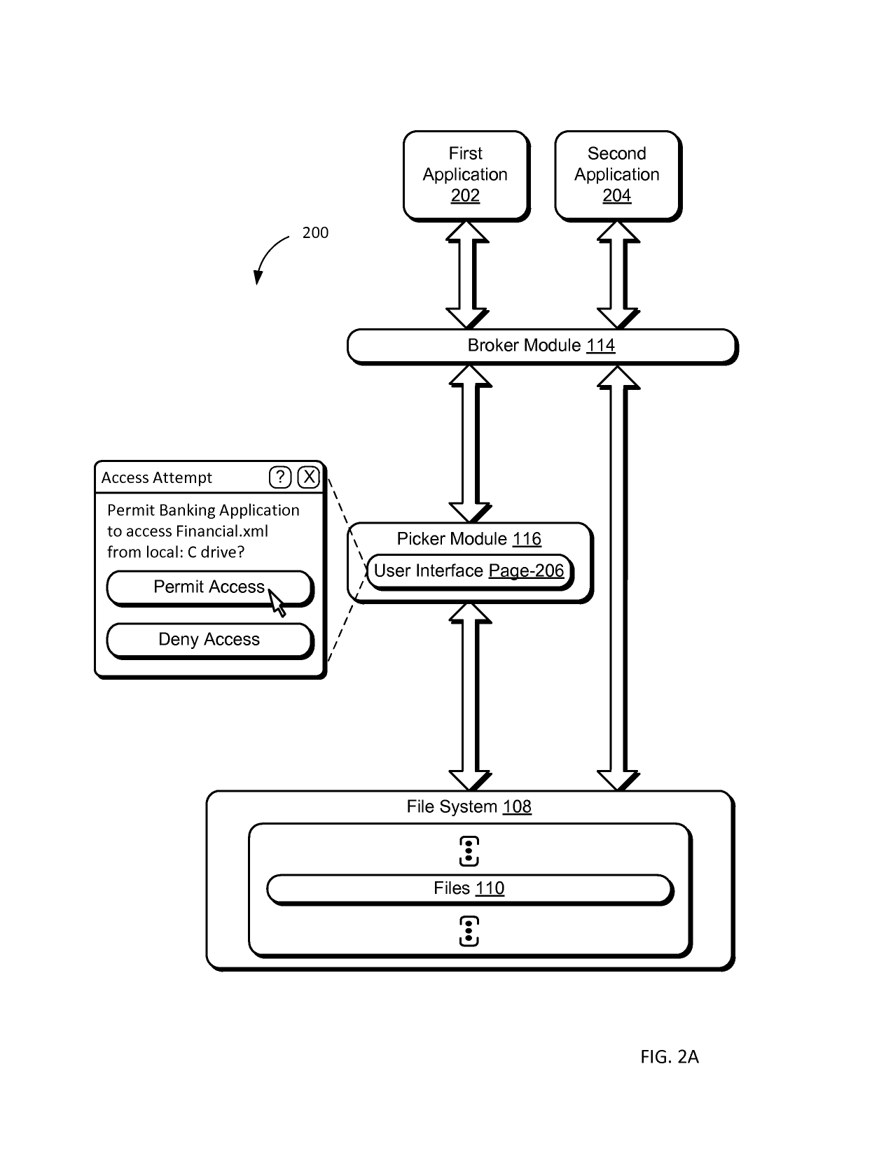

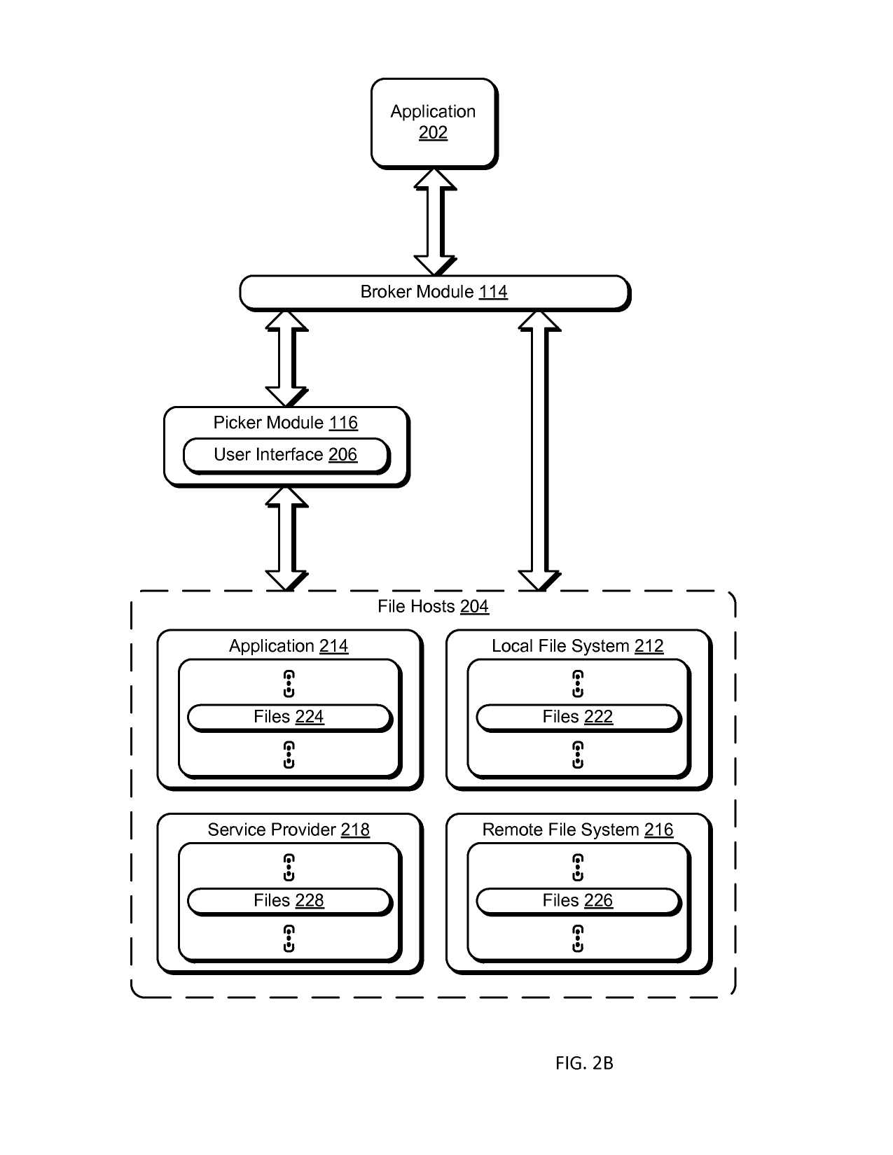

FIG. 2A is an illustration of a system 200 in an example implementation configured to perform file management. The system 200 as illustrated may be implemented by the file management module 106 of the computing device 102 to perform file management techniques. For example, the file management module 106 may be incorporated as part of an operating system, an application that executes in conjunction with the operating system, a stand-alone application, and so on. Regardless of where incorporated, the file management module 106 may employ techniques to manage files 110, 118 accessible to the computing device 102 locally and/or remotely via the network 104, e.g., from the service provider 120.

The system 200 as illustrated includes a first application 202 and a second application 204, which may or may not correspond to the application 112 described in relation to FIG. 1. In this example, both the first and second applications 202, 204 communicate with the broker module 114 via one or more application programming interfaces to access the file system 108.

In the case of the second application 204, a determination has been made that access to the file system 108 is trusted or in other words, the second application 204 is trustworthy. For example, the second application 204 may be coded by a reputable software provider, tested for compatibility, and so on. Accordingly, the second application 204 may be permitted by the broker module 114 to access the file system 108 without verification by the picker module 116.

In one implementation, this access is permitted without the second application 204 “knowing” where and/or how particular files 110 are arranged in the file system 108. The second application 204, for instance, may be unaware of a namespace used to access the files 110 in the file system 108. Therefore, the broker module 114 may convert requests from the second application 204 received via the API into a form that are understandable to locate files 110 of interest. In this way, the broker module 114 may still protect and manage access granted to the second application 204.

In another implementation, the second application 204 may be made aware of where and/or how the files 110 are arranged and located within the file system 108. For instance, the second application 204 may be configured to use a namespace supported by the file system 108 such that conversion of the request is not performed by the broker module 114. A variety of other examples are also contemplated, such as to enable direct access to the file system 108 without interacting with the broker module 114 to fully-trusted applications.

In the case of the first application 202 in the example illustrated in FIG. 2A, a determination may be made that access to the file system 108 is not trusted, e.g., partially trusted or not permitted whatsoever. In response, the broker module 114 may employ the picker module 116 to verify access to the file system 108 that is requested by the first application 202. The first application 202, for instance, may communicate a request via one or more APIs to the broker module 114 to access the file system 108.

The broker module 114, upon receiving this request, may implement the picker module 116 to generate a user interface 206. The user interface 206 in this example is shown as a portion that includes a description of what access is being request and “what” is requesting the access, e.g., identify the first application 202. The user interface 206 is also illustrated as including an option (e.g., “permit access” button) that is selectable to permit the requested access. An option to deny the access (e.g., “Deny Access” button) is also included in the user interface 206. Information within the portion of the user interface 206 may be output such that the first application 202 is not aware of what is contained therein and therefore is not made aware of a location of the requested data.

If the user selects the option to permit access (e.g., which is illustrated as selecting the Permit Access button using a cursor control device), the picker module 116 may permit access to the requested file 110. A variety of different types of access may be managed by the broker and picker modules 114, 116, singly or in combination. Examples of such access including saving a file 110, opening a file 110, modifying a file 110, moving files 110, and so forth.

The picker module 116 may be configured to provide access to the files 110 via the broker module 114 to the first application 202 in a way such that the first application 202 is unaware of a namespace used by the file system 108 to manage the files 110. Thus, the picker module 116 may protect the file system 108 from access by untrustworthy applications by confirming this access via the user interface 206.

In one or more implementations, the broker module 114 may oversee a plurality of picker modules 116, each configured for a respective one of a plurality of applications. Thus, the broker module 114 and the picker module 116 may provide techniques to manage access to the files 110 by the first and second applications 202, 204 while reducing a likelihood that the execution of the applications may compromise the computing device 102 and/or other computing devices, e.g., one or more computing devices that implement the service provider 120 of FIG. 1.

FIG. 2B illustrates another example system 201 implementing the file access with different file hosts techniques discussed herein in accordance with one or more embodiments. System 201 as illustrated may be implemented in part by file management module 106 of computing device 102 of FIG. 1 to perform file management techniques.

System 201 as illustrated includes application 202 (which can be, for example, an application 112 of FIG. 1), a broker module 114, a picker module 116, and one or more file hosts 204. In this example, application 202 communicates with broker module 114 via one or more application programming interfaces (APIs) exposed by broker module 114 to access file hosts 204. Although a single application 202 and particular files hosts 204 are illustrated in FIG. 2B, it should be noted that system 201 can include any number of applications 202 accessing any number of file hosts 204.

In one or more embodiments, application 202 is permitted to access file hosts 204 without being aware of where and/or how particular files are arranged, organized, maintained, and so forth by file hosts 204. Application 202, for instance, may be unaware of a namespace or data model used to access files by file hosts 204. Therefore, broker module 114 may convert requests from application 202 received via the APIs into a form that is understandable to locate files of interest.

In other embodiments, application 202 may be made aware of where and/or how files are arranged and located within particular file hosts 204. For instance, application 202 may be configured to use a namespace supported by local file system 212 such that conversion of the request is not performed by broker module 114. A variety of other examples are also contemplated, such as to enable direct access to local file system 212 without interacting with broker module 114 for particular applications (in which case files can be accessed via other user interfaces other than user interface 206 discussed below).

Picker module 116 presents a user interface 206 facilitating user selection of files for retrieval and/or destinations for saving files. User interface 206 allows files to be retrieved from and/or saved to various file hosts. For example, user interface 206 can include a hosted area in which a user interface generated by a file host 204 is displayed.

Broker module 114 and picker module 116 act as intermediaries between application 202 and file hosts 204. Applications 202 may be unaware of file hosts 204, and file hosts may be unaware of application 202. Additionally, user interface 206, including the hosted area in which file hosts 204 can display a portion of the user interface, is provided by picker module 116. Thus, application 202 may be unaware of the particular file host displaying a user interface in the hosted portion at any given time, as well as be unaware of the particular file host 204 from which files are accessed (e.g., which file host 204 files are retrieved from or saved to).

Broker module 114 and/or picker module 116 can communicate with various different file hosts 204, such as local file system 212, application 214, remote file system 216, and service provider 218. Broker module 114 and/or picker module 116 can communicate with file hosts 204 in different manners, and in one or more embodiments modules 114 and/or 116 are configured with (or can otherwise obtain) information indicating how to communicate with each of the file hosts 204.

A file host 204 refers to a system, service, application, and so forth that organizes, manages, and/or stores files. A file host 204 can display a user interface in a hosted area, allowing files of the file host (files that the file host organizes, manages, and/or stores) to be accessed (e.g., retrieved, stored, and so forth). A file host 204 can organize and store files in various different manners using various different data models (the format and/or protocol used in storing files), such as storing files as individual files on a storage device, as files in a database or other record, as part of grouping or collection of files (e.g., as part of a zip or cabinet file), and so forth. Regardless of the data model used by file hosts 204, each file host 204 is aware of how to access (e.g., identify, store, retrieve, modify) the files that that file host 204 organizes, manages, and/or stores.

Local file system 212 is a file host that stores files 222 in one or more folders on local storage devices that are part of or connected to the computing device running application 202, including removable storage devices. Local file system 212 can, for example, store files 222 on local hard disks, optical discs, Flash memory devices, or other computer-readable storage media.

Remote file system 216 is a file host that stores files 226 in one or more folders on a remote storage device that is not the same computing device as is running application 202. For example, the remote storage device can be coupled to the computing device running application 202 via network 104 of FIG. 1. Remote file system 216 can store files on various different computer-readable storage media, analogous to local file system 212.

Application 214 can assume a variety of different configurations, and can be one or more programs, scripts, or other collections of instructions run on various devices, analogous to application 112 of FIG. 1. Application 214 can also be an isolated application, analogous to application 112 of FIG. 1. Application 214 is typically running on the same computing device as application 202, although can alternatively be running on another computing device. Application 214 is a file host that stores files 224 in various manners. Application 214 can leverage local file system 212 and/or remote file system 216 to store files 224, but files 224 are typically accessible only through application 214.

Service provider 218 is one or more applications that can assume a variety of different configurations, providing various services to application 202 such as photo management services, social networking services, messaging or other communication services, document editing services, and so forth. Service provider 218 includes one or more applications that are typically running on one or more different computing devices than application 202, such as on one or more computing devices coupled to the computing device running application 202 via network 104 of FIG. 1. Service provider 218 is a file host that stores files 228 in various manners. Service provider 218 can leverage local file system 212 and/or remote file system 216 to store files 228, but files 228 are typically accessible only through service provider 218.

When application 202 desires to access a file host, such as to allow a user of application 202 to select one or more files for retrieval into application 202 or save one or more files from application 202, application 202 communicates a file access request to broker module 114. Because application 202 is making the file access request, application 202 is also referred to as the calling application. The file access request is communicated, for example, by invoking an API of broker module 114. In response to the file access request, broker module 114 invokes picker module 116, which displays user interface 206. Alternatively, application 202 can bypass broker module 114 and communicate a file access request to picker module 116, invoking picker module 116 directly to display user interface 206 without going through broker module 114.

User interface 206 includes a hosted area, which is a portion of the user interface in which one or more file hosts 204 can display a user interface. The user interface displayed within the hosted area is generated by a file host 204. An application 214 or service provider 218 displaying a user interface within the hosted area can also be referred to as a hosting application. Each file host 204 can tailor the display within the hosted area as that file host 204 desires, optionally modifying and changing that display over time as that file host 204 desires. Application 202 can be unaware of (and have no knowledge of) the manner in which the user interface displayed within the hosted area is generated, the data model or namespace used by the file host 204, and so forth. Similarly, picker module picker module 116 can be unaware of (and have no knowledge of) the manner in which the user interface displayed within the hosted area is generated, the data model or namespace used by the file host 204, and so forth.

Picker module 116 (e.g., UI module 122 of picker module 116) provides the hosted area in which one or more file hosts 204 can display a user interface. The hosted area can be, for example, a window in which the user interface of a file host 204 can be displayed or otherwise presented. The user interface can be displayed within the hosted area in different manners. For example, the user interface to be displayed within the hosted area can be received from a file host 204 and displayed by picker module 116. By way of another example, the file host 204 can be allowed to directly display the user interface in the hosted area (e.g., in a particular window). However, regardless of the manner in which the user interface is displayed within the hosted area, the user interface of the file host is restricted to that host area. The user interface of the file host is not permitted to overwrite other areas of the UI not within the hosted area, and is not permitted to preempt the UI provided by the operating system of the computing device or other applications running on the computing device.

It should be noted that, as picker module 116 provides the hosted area in which one or more file hosts 204 can display a user interface, the hosted area is not provided by a plug-in or extension code incorporated into application 202. In addition to being unaware of (and having no knowledge of) the manner in which the user interface displayed within the hosted area is generated, application 202 can be unaware of the particular file host generating the user interface displayed within the hosted area. The particular file host generating the user interface displayed within the hosted area, as well as the file hosts 204 available to generate the user interface displayed within the hosted area, can change without application 202 being aware of the changes.

User interface 206 can display a single hosted area in which a single file host 204 can display a user interface at a time, and the file host 204 displaying a user interface within the hosted area can change over time. Alternatively, user interface 206 can display multiple hosted areas concurrently, allowing multiple file hosts 204 to display user interfaces concurrently.

Picker module 116 can identify a file host 204 to display a user interface within the hosted area in different manners. In one or more embodiments, identifiers of various file hosts 204 are presented as part of user interface 206, such as in a file host identification portion of user interface 206. A user input selecting one of the identifiers is received, and picker module 116 invokes the file host 204 having the selected identifier to display a user interface within the hosted area. Alternatively, picker module 116 can identify a file host 204 to display a user interface within the hosted area in other manners, such as by identifying a default file host (e.g., that picker module 116 is configured with or can otherwise identify), selecting a file host randomly or according to other rules or criteria, identifying a file host based on a preference or configuration setting received from a user of system 201, and so forth.

The file hosts 204 available in system 201 can be determined in different manners. In one or more embodiments, each file host 204 is registered as being a file host 204 for picker module 116. As part of a registration process, various information regarding file host 204 is provided, such as how to activate the file host 204, file types supported by the file host, and so forth. This registration can be performed at various times, such as when the file host is installed on a computing device implementing picker module 116, when the file host accesses a computing device implementing picker module 116, in response to a user request, and so forth. When determining the file hosts 204 available in system 201 (e.g., and thus the file hosts 204 for which identifiers are to be displayed within a file host identification portion of user interface 206), picker module 116 can identify only those file hosts that have registered as being a file host 204 for picker module 116.

Alternatively, the file hosts 204 available in system 201 can be identified in different manners. For example, a remote service can be accessed (e.g., via network 104 of FIG. 1) to identify services currently accessible by the computing device running application 202, and those identified services can be file hosts 204. By way of another example, a list of file hosts from a vendor or administrator of the computing device running application 202 can be accessed to determine the file hosts 204 available in system 201.

Additionally, in one or more embodiments file hosts 204 can support different file types. A file type refers to a particular type of data stored in the file and/or format in which data is stored in a file. For example, file types can be images files, audio files, video files, text files, and so forth. By way of another example, file types can be JPEG (Joint Photographic Experts Group) files, PDF (Portable Document Format) files, and so forth. A file type being supported by a file host 204 refers to the file host 204 organizing, managing, and/or storing files having that file type. The file types supported by each file host 204 are identified, such as during the registration process discussed above. As part of a file access request, application 202 can identify one or more file types that application 202 desires for that file access request. Picker module 116 identifies (e.g., as file hosts 204 for which identifiers are to be displayed within a file host identification portion of user interface 206) only those file hosts that support the file type requested by application 202. Thus, a file host 204 that does not support a file type requested by application 202 is not identified as a file host that can display a user interface within the hosted area. However, if a subsequent access request from application 202 is received for another file type that is supported by that file host 204, then that file host 204 is identified as a file host that can display a user interface within the hosted area.

When a file host 204 is identified as the file host 204 to display a user interface within the hosted area, the identified file host 204 is activated or otherwise invoked by picker module 116. Picker module 116 is aware of, or can obtain, information indicating how to activate or invoke a file host 204. This information can be obtained, for example, as part of a registration process as discussed above. If the file host 204 is not already running then picker module 116 activates or launches the file host 204, invoking the file host 204 to display a user interface within the hosted area. If the file host 204 is already running, then picker module 116 invokes the file host 204 to display a user interface within the hosted area.

The activated or invoked file host 204 displays the user interface in the hosted area in various manners as determined by the file host 204 itself. Files can be displayed with different representations, such as icons, video sequences, text descriptions, and so forth. Data can be input by a user in different manners, such as via a text entry field, via gestures, audibly, and so forth.

The user interface displayed by the file host 204 in the hosted area can allow various accesses to files managed by the file host 204. For example, the user interface can allow navigating through folders or other groupings of files, selecting one or more files for retrieval, selecting one or more locations for saving a file, and so forth.

In situations in which the file access request from application 202 is requesting to retrieve one or more files, the user interface displayed by the file host 204 identifies (e.g., displays icons or thumbnails representing) one or more files of each of one or more file hosts 204 from which the user of application 202 can select. The selection can be made by the user providing a variety of different inputs as discussed above. Upon selection of one or more files (from one or more file hosts 204), the one or more file hosts 204 provide the selected one or more files (or an indication of where and/or how to retrieve the one or more selected files) to picker module 116. Picker module 116 provides the one or more selected files (or an indication of where and/or how to retrieve the one or more selected files) to broker module 114. Broker module 114 returns to application 202 the one or more selected files (or alternatively an indication of where and/or how application 202 can retrieve the selected one or more files or the content of the one or more files).

In situations in which the file access request from application 202 is requesting to save or store one or more files, the user interface displayed by the file host 204 identifies (e.g., displays icons or thumbnails representing) one or more locations of the file host 204 from which the user of application 202 can select. The user interface displayed by the file host 204 can also provide a user input portion allowing the user to provide various information regarding the one or more files (e.g., names of the one or more files, descriptions of the one or more files). As part of the file access request to save or store a file, application 202 can optionally provide information identifying the file. This information can be provided to the file host 204 displaying the user interface in the hosted area, allowing the file host 204 to incorporate information regarding the file to be saved in the user interface in the hosted area. For example, application 202 can provide to the file host 204 (via broker module 114 and picker module 116) a thumbnail or icon representing the file to be saved. The file host 204 can display this thumbnail or icon as part of the user interface in the hosted area.

Application 202 provides the one or more files to be saved (or an indication of where and/or how to obtain the one or more files to be saved) to broker module 114. Broker module 114 provides the one or more files to be saved (or an indication of where and/or how to obtain the one or more files to be saved) to picker module 116, which provides the one or more files to be saved (or an indication of where and/or how to obtain the one or more files to be saved) to the file host 204 displaying the user interface in the hosted area. Upon receiving a user selection of a location to store the one or more files, the file host 204 displaying the user interface in the hosted area stores the one or more files in the selected location (and optionally with the additional provided information regarding the one or more files). Application 202 can provide the one or more files to be saved (or an indication of where and/or how to obtain the one or more files to be saved) as part of the file access request, or alternatively at other times (e.g., in response to a request for the one or more files from picker module 116, the request provided by picker module 116 in response to a user selection of a location where the one or more files are to be saved).

In system 201, application 202 is a calling application providing access requests to broker module 114, and application 214 is a hosting application that can provide a user interface in a hosted area of user interface 206. However, it should be noted that an application can be a hosting application and/or a calling application at the same and/or different times. For example, application 202 can be a social networking application and application 214 can be a photo editing application. The social networking application can be the hosted application and the photo editing application can be the calling application at one point in time allowing images to be retrieved from the social networking application into the photo editing application, and at a later point in time the photo editing application can be the hosted application and the social networking application can be the calling application allowing images to be retrieved from the photo editing application into the social networking application. Continuing with this example, while the photo editing application is the calling application with respect to the social networking application, a word processing application can be a calling application and the photo editing application can be a host application for the word processing application, thus allowing images to be retrieved from the photo editing application into the word processing application concurrently with allowing images to be retrieved from the social networking application into the photo editing application.

The file access with different file hosts techniques discussed herein support various usage scenarios. For example, while using a particular application, a user is able to request that files of a particular type (e.g., pictures) be retrieved into that one application. Various other applications or service providers that support files of that particular type can be identified and display user interfaces to the user. The user is able to select one or more files from those various other applications, in response to which the selected one or more files are retrieved into the particular application the user is using. The user can thus easily retrieve into the particular application files from another application without having to separately save files from the other application onto a storage device, and then retrieve those saved files into the particular application. Furthermore, the user can retrieve such files from the other application while the particular application into which the files are being retrieved is unaware of the data model used by the other application (and unaware of the other application itself).

Updating/Accessing a File from a Different File Host

With the context of the computing environment described above in reference to FIGS. 1, 2A and 2B, it will now be described some mechanism for updating/accessing a file from a different file host.

The operating system's file system is typically used as the medium in which applications update/access a file. As a result, explicit user action is typically used to move file data between apps.

In addition, the current method of accessing a file with different file hosts takes a “snapshot” of the file and does not allow for versioning. In some cases, the file the user is interacting with might not be the latest version (e.g., as it may have been updated on the file host independently).

In a number of embodiments, the present system may provide for several areas of functionality that pertain to more accurate and efficient file usage between applications. For example, in one embodiment, the system may enable an application to obtain updated files from a file host application that would otherwise be inaccessible. In another embodiment, the system may enable an application to save an updated file to a file host application. In yet another embodiment, the system may provide a user interface for export operations and file host application intervention.

In these various embodiments, the system may provide for the one or more of the following functionalities: (1) refreshing content that is controlled by a file host application; (2) updating content that is controlled by a file host application; (3) exporting files from an application to a file host application; (4) a user interface for export operations and file host application intervention and (5) a file host extensibility point provided by the operating system.

In one embodiment, Picker module may comprise a file picker extensibility point that would enable applications to acquire files from other applications through an operating system-provided user experience (UX). Such a Picker and associated UX may be a way to both allow and simultaneously affect applications to work seamlessly with content provided by other applications—as there is no functional distinction between a local file and a file picked from an application. Although there may be a method for a corresponding symmetric File Save Picker UX, there is no corresponding data contract enabling the user to send data to another application—instead they may only choose file system locations. To send data to another application, it may be possible to have a separate user invoked Share contract.

In addition, existing data transfer contracts typically limit applications to only interchanging data through user-invoked UX. While providing great user predictability, this may prevent applications from establishing longstanding connections to one another for data interchange.

Thus, it may be desirable for several of the present embodiments of the system to enable updating/accessing of files and enable applications to maintain persistent connections with one another once established. In one embodiment, this may be accomplished via an operating system affordance mechanism where apps can declaratively opt-in to participate as a file host on the system.

It will now be described how platform components may handle file host app activation and data transfer between applications, including methods to expose functionality to both the app and file host applications.

In order to create a “connection” from an app to a file provided by a file host app, it may be desirable that file host apps participate in requests to read and/or write data from the file. Thus, file host apps may be activated on-demand when an app issues such a data request on a file obtained from the file host app (via the Picker).

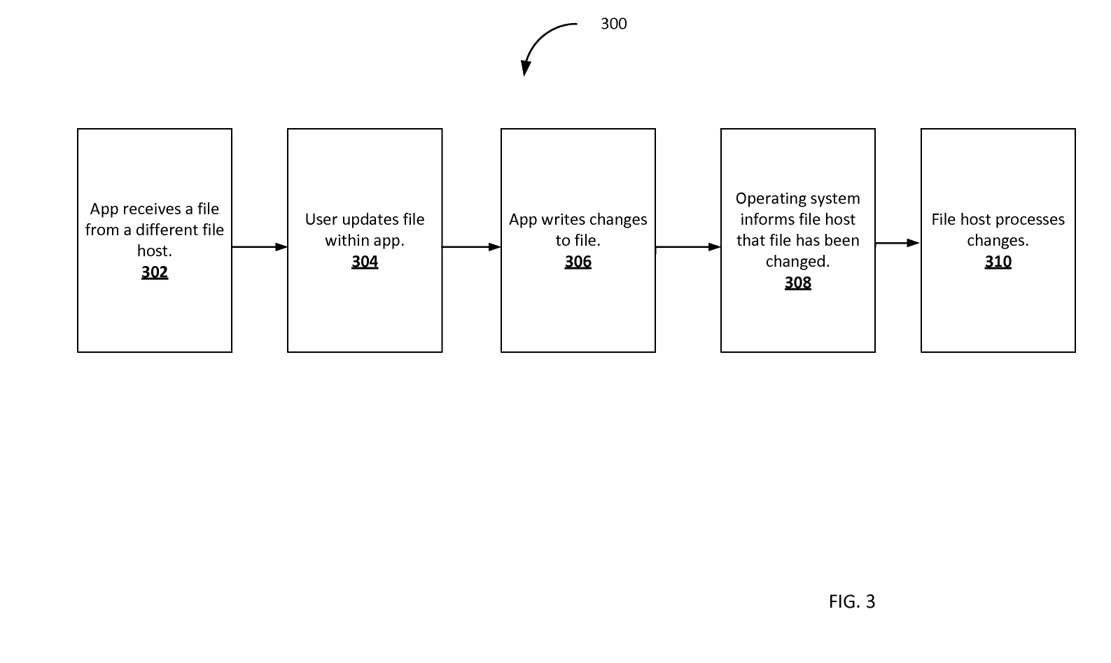

FIG. 3 depicts a high-level flow diagram in one embodiment of a present system for such connection in the context of “Save” example. Example 300 starts at 302, with an app receiving a remote file from a different file host. In the normal course of using the file, user may update the file within the app (e.g., issue a “save” command) at 304. App, at 306, writes the changes to the file. The operating system informs the file host that the file has been changed. At 310, the file host app then processes the changes. It will be appreciated that other Save examples and mechanisms are possible and are encompassed by the scope of the present application.

Exporting a File to a Different File Host

While there are some similarities between saving a file to a different file host and updating and/or accessing a file from a different file host functionalities, some differences are noted herein.

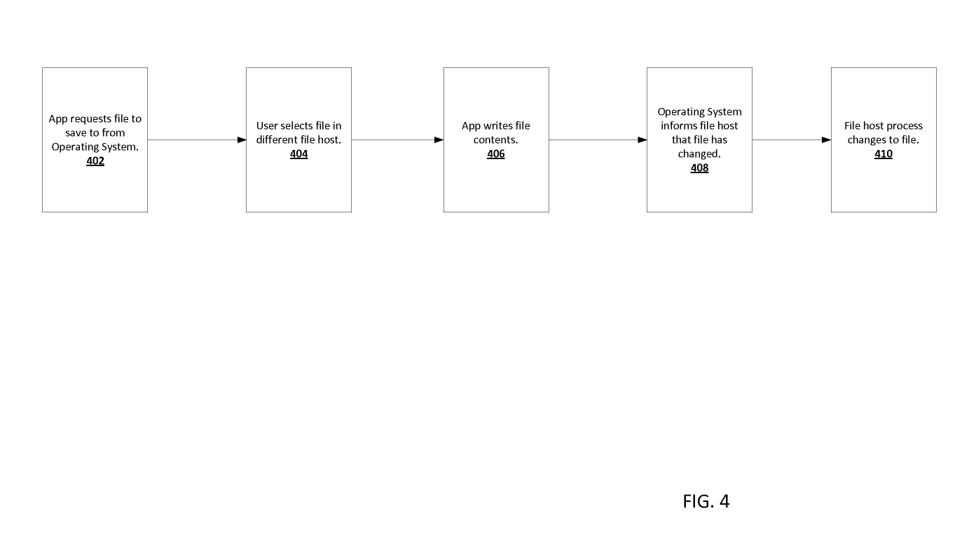

FIG. 4 depicts a high-level flow diagram for exporting a file to a different file host functionality. In one embodiment, app requests a file to save to from the operating system at 402 and user selects the file in a different file host at 404. Thereafter, app writes file contents at 406. The operating system thereafter informs the file host that the file has changed at 408 and file host app processes the changes to the file at 410.

In one embodiment, the file host app may be activated when it is initially hosted in the File Picker to display its UX for saving a file and after the File Picker is closed until it has completed writing the data. Depending upon how the file host provides the file it may only be updated on subsequent writes using the Export functionality detailed herein.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for updating a file accessed by a first application, from a file host not directly accessible to said first application, the steps of said method comprising:
requesting to access a file by the first application, said first application being unaware of the namespace of files residing on a file host not directly accessible to the first application;
accessing said file by said first application via a user interface;
requesting writing changes to said file via said user interface;
informing said file host not directly accessible to the first application that said file has been changed; and
changing said file by said file host not directly accessible to said first application.

2. The method of claim 1 wherein the step of accessing said file by said first application further comprising accessing said file by a picker module.

3. The method of claim 2 wherein said picker module further comprises a file picker extensibility point.

4. The method of claim 3 wherein said file picker extensibility point provides the user with an operating system user experience.

5. The method of claim 4 wherein said operating system user experience comprises an operating system affordance mechanism.

6. The method of claim 5 wherein application may opt-in to participate as a file host.

7. The method of claim 1 wherein said file host participates in requests to read or write data from said file.

8. A method for updating a file accessed by a first application, to a file host not directly accessible to said first application, the steps of said method comprising:
requesting to update a file by the first application, said first application being unaware of the namespace of files residing on a file host said file residing on a file host not directly accessible to the first application;
selecting said file by said first application via a user interface;
writing changes to said file by said first application via a user interface;
informing said file host that said file has changed; and
processing said changes to said file by said file host.

9. The method of claim 8 wherein said step of requesting to update a file further comprises said first application requesting said file from the operating system.

10. The method of claim 9 wherein said step of informing said file host further comprises the operating system informing said file host that said file has been changed.
